(19) United States
(12) Patent Application Publication
(10) Pub. No.: US 2007/0064622 A1
(43) Pub. Date: Mar. 22, 2007

(54) Interactive voice response based troubleshooting of customer premise equipment installation

(75) Inventors: Haifeng Bi, San Antonio, TX (US); William R. Hurst, San Antonio, TX (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/227,207

(22) Filed: Sep. 16, 2005

(51) Int. Cl. H04L 12/28

(52) U.S. Cl. 370/254

(57) ABSTRACT

Troubleshooting of customer premise equipment installation includes sending information over a communications network to attempt to activate customer premise equipment. A request is received to activate an interactive voice response based troubleshooting component of the customer premise equipment. Information relating to the attempt to activate the customer premise equipment is provided using the interactive voice response based troubleshooting component of the customer premise equipment.

### BACKGROUND OF THE INVENTION

1. Field of the Invention

The present invention relates to customer premise equipment (CPE) installation. More particularly, the present invention relates to interactive voice response (IVR) based troubleshooting of CPE installation.

2. Background Information

Currently, to activate voice over internet protocol (VoIP) service, an installer is typically required to install special-purpose VoIP CPE. The VoIP CPE may be an analog terminal adapter (ATA), an internet protocol (IP) phone or another internet protocol telephony device. The installation of the VoIP CPE can be performed by the end user or a technician of the VoIP service provider.

Before VoIP CPE is ready for its first use, it must be installed and properly provisioned. The CPE must first communicate with a file server in the service provider's network and request a configuration file which contains operation instructions. Then the CPE must register with a registration server in the service provider's network. Only when these steps are successfully completed will the CPE be able to provide the installer with a dial tone. If anything goes wrong with this process, the installation will fail, and the installer will not be able to start using the VoIP service.

Currently, if the CPE installation fails, the installer may receive certain visual or audible indications of the failure. For example, failure may be indicated by a light on the CPE that is either dim or lit in a color that indicates a problem. Alternatively, the installer may not be able to detect a dial tone. While these indicators indicate that the installation has failed, they do not give more detailed information about the error, e.g., whether the problem is with the file server or the registration server.

With most VoIP CPE, the detailed information about the error is present on the CPE. To retrieve the error information, a computer needs to be connected to the CPE directly or via a wired network. However, a VoIP service provider's technician is often not equipped with a notebook personal computer due to, e.g., cost considerations of the service provider and connectivity concerns. Further, many CPE end users do not have a personal computer. Therefore, it is not always possible to retrieve the error information with a computer during the CPE installation.

Accordingly, a need exists for interactive voice response based troubleshooting of customer premise equipment installation. To solve the above-described problems, interactive voice response based troubleshooting of customer premise equipment installation is provided.

### BRIEF DESCRIPTION OF THE DRAWINGS

FIG. 1 shows an exemplary general computer system that includes a set of instructions for performing interactive voice response based troubleshooting of customer premise equipment installation;

FIG. 2 shows an exemplary method for interactive voice response based troubleshooting of customer premise equipment installation;

FIG. 3 shows an exemplary setup of customer premise equipment that is connected to a network; and

FIG. 4 shows exemplary customer premise equipment by which interactive voice response based troubleshooting of customer premise equipment installation can be provided.

### DETAILED DESCRIPTION

In view of the foregoing, the present invention, through one or more of its various aspects, embodiments and/or specific features or sub-components, is thus intended to bring out one or more of the advantages as specifically noted below.

According to an aspect of the present invention, a method for installing customer premise equipment is provided. The method includes sending information from customer premise equipment over a communications network to attempt to activate the customer premise equipment. The method also includes receiving a request to activate an interactive voice response based troubleshooting component of the customer premise equipment. Information relating to the attempt to activate the customer premise equipment is provided using the interactive voice response based troubleshooting component of the customer premise equipment.

According to another aspect of the present invention, the customer premise equipment is voice over internet protocol customer premise equipment.

According to still another aspect of the present invention, the voice over internet protocol customer premise equipment is one of an analog terminal adapter and an internet protocol phone.

According to yet another aspect of the present invention, the voice over internet protocol customer premise equipment is one of an integrated access device and a residential gateway.

According to another aspect of the present invention, the method includes receiving the request as dual tone multi-frequency tones.

According to still another aspect of the present invention, the information includes a diagnosis menu.

According to yet another aspect of the present invention, the information includes an error code corresponding to a reason the attempt to activate the customer premise equipment has failed.

According to an aspect of the present invention, a computer readable medium is provided for storing a computer program that provides information for installing customer premise equipment. The computer readable medium includes an information sending code segment that sends information from customer premise equipment over a communication network to attempt to activate the customer premise equipment. A request receiving code segment receives a request to activate an interactive voice response based troubleshooting component of the customer premise equipment. An information providing code segment provides information relating to the attempt to activate the customer premise equipment using the interactive voice response based troubleshooting component of the customer premise equipment.

According to another aspect of the present invention, the customer premise equipment is voice over internet protocol customer premise equipment.

According to still another aspect of the present invention, the voice over internet protocol customer premise equipment is one of an analog terminal adapter and an internet protocol phone.

According to yet another aspect of the present invention, the voice over internet protocol customer premise equipment is one of an integrated access device and a residential gateway.

According to another aspect of the present invention, the request is received as dual tone multi-frequency tones.

According to still another aspect of the present invention, the information includes a diagnosis menu.

According to yet another aspect of the present invention, the information includes an error code corresponding to a reason the attempt to active the customer premise equipment has failed.

According to an aspect of the present invention, customer premise equipment is provided. The customer premise equipment includes a transmitter that sends information over a communications network to attempt to activate the customer premise equipment. The customer premise equipment also includes an interactive voice response based troubleshooting component that provides information relating to the attempt to activate the customer premise equipment. The customer premise equipment also includes an input component that receives a request to activate the interactive voice response based troubleshooting component of the customer premise equipment.

According to another aspect of the present invention, the customer premise equipment is voice over internet protocol customer premise equipment.

According to still another aspect of the present invention, the voice over internet protocol customer premise equipment is one of an analog terminal adapter and an internet protocol phone.

According to yet another aspect of the present invention, the voice over internet protocol customer premise equipment is one of an integrated access device and a residential gateway.

According to another aspect of the present invention, the request is received as dual tone multi-frequency tones.

According to still another aspect of the present invention, the information includes a diagnosis menu.

According to yet another aspect of the present invention, the information includes an error code corresponding to a reason the attempt to activate the customer premise equipment has failed.

According to another aspect of the present invention, the interactive voice response based troubleshooting component includes a troubleshooting processor and interactive voice response troubleshooting instructions.

The present invention enables a person installing and/or configuring CPE to troubleshoot installation problems using the CPE. In particular, the present invention enables a person to troubleshoot installation and/or configuration problems when installing and/or configuring VoIP CPE such as a VoIP phone or an analog terminal adapter and analog telephone. The installation of the VoIP CPE can be performed by the end user or a technician of the VoIP service provider.

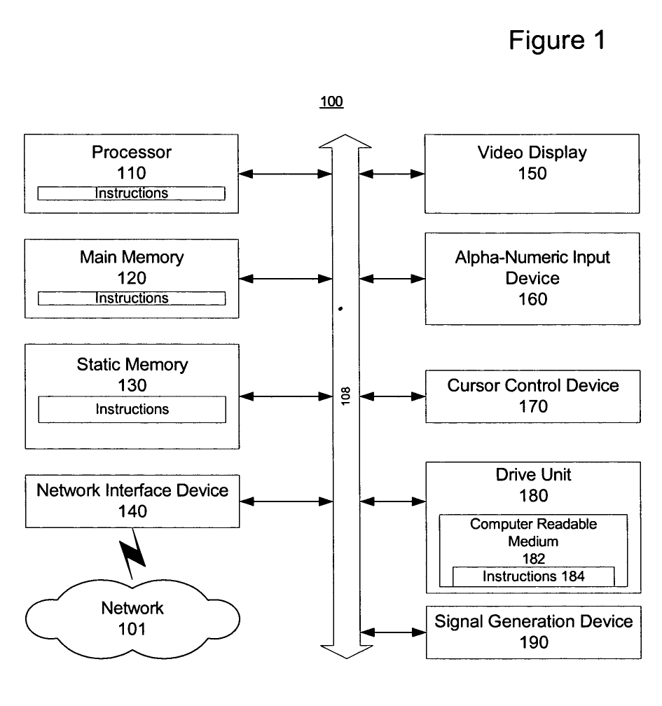

Referring to FIG. 1, an illustrative embodiment of a general computer system, on which interactive voice response based troubleshooting of customer premise equipment installation can be implemented, is shown and is designated 100. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), an internet protocol (IP telephone), an analog terminal adapter (ATA), a palmtop computer, a desktop computer, a communications device, a land-line telephone, a control system, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

An installer can attempt to install, configure and/or activate VoIP CPE which can include a general computer system as shown in FIG. 1. When the VoIP CPE is not successfully activated, information relating to the reason(s) the attempt has failed can be provided using interactive voice response functionality of the general computer system.

An installer of VoIP CPE can be an end user or a technician of the VoIP service provider. In an embodiment, if the installer is an end user such as a customer, the method described below may be used by a VoIP service provider's technical support people when the customer calls in for help. The VoIP service provider's technical support people may ask the customer to listen to interactive voice response information provided by the CPE. The VoIP service provider's technical support people may then use the information to remotely guide the customer in properly installing the CPE.

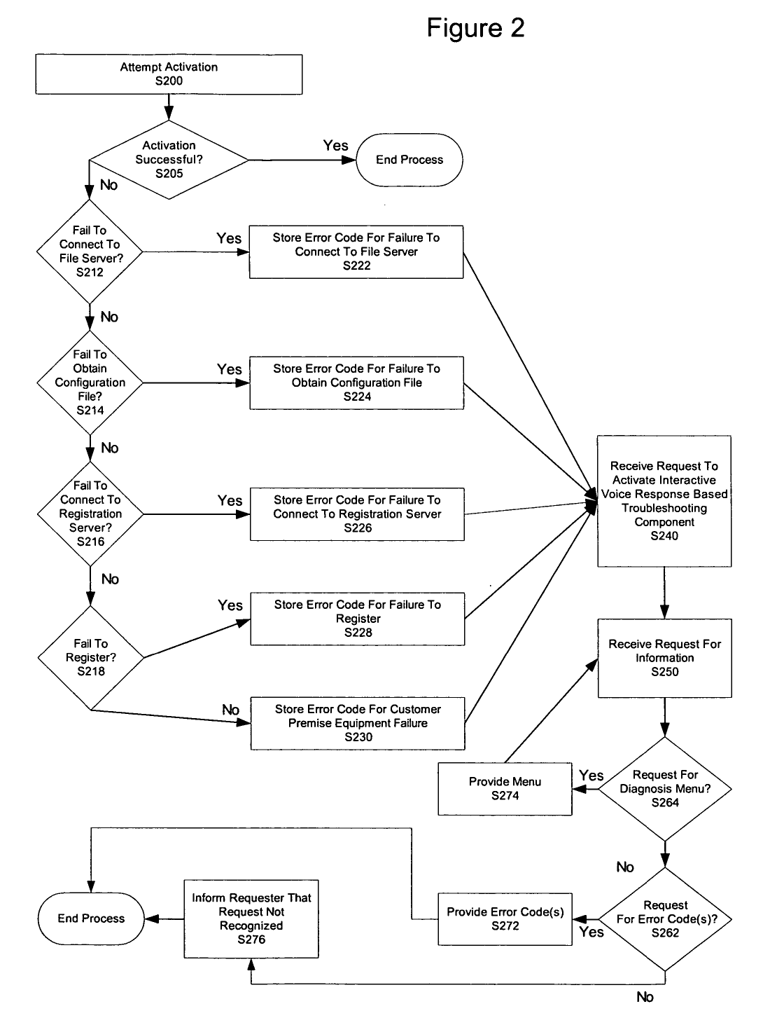

FIG. 2 shows an exemplary method for interactive voice response based troubleshooting of customer premise equipment installation. The process starts when an attempt is made to activate CPE at S200. A determination is made at S205 whether the activation attempt is successful. If the activation attempt is successful (S205=Yes), the process ends.

If the activation attempt is unsuccessful (S205=No), one or more determinations are made as to the cause of the failure. The causes determined to be attributable to the failure may be related to information provided from network servers, or may be based on simple determinations that a particular process or action has not successfully completed.

At S212, a determination is made whether there was a failure to connect to a file server. If there was a failure to connect to a file server (S212=Yes), an error code for the failure to connect to the file server is stored at S222. If there was no failure to connect to a file server (S212=No), a determination is made at S214 whether there was a failure to obtain a configuration file. If there was a failure to obtain a configuration file (S214=Yes), an error code for the failure to obtain a configuration file is stored at S224. If there was no failure to obtain a configuration file (S214=No), a determination is made at S216 whether there was a failure to connect to a registration server. If there was a failure to connect to a registration server (S216=Yes), an error code for the failure to connect to a registration server is stored at S226. If there was no failure to connect to a registration server (S216=No), a determination is made at S218 whether there was a failure to register. If there was a failure to register (S218=Yes), an error code for the failure to register is stored at S228. If there was no failure to register (S218=No), an error code for CPE failure is stored at S230.

It should be noted that the determinations at S212, S214, S216 and S218, and the error codes that are stored at S222, S224, S226, S228 and S230, are exemplary and non-limiting. Failures related to activation attempts may be due to numerous reasons in addition to the exemplary reasons listed herein, and additional determinations of cause are contemplated within the scope of the present invention.

Additionally, the process is not limited to identifying only a single cause for a failure to activate CPE. Rather, in another embodiment, after an error code is stored at S222, S224, S22, 228 and/or 230, the process may loop back to a subsequent determination at S212, S214, S216 and/or S218 to determine whether additional errors have occurred.

After an error code is stored at S222, S224, S226, S228 or S230, the process waits to receive a request to activate an interactive voice response based troubleshooting component of the CPE at S240. In an embodiment, the request to activate the interactive voice response based troubleshooting component at S240 occurs when a person trying to install the CPE presses a button on the CPE. The button may be dedicated to activating the interactive voice response based troubleshooting component, or may be a selection button that can be used to select one of several interactive voice response components for the CPE. For example, the interactive voice response based troubleshooting component may provide the error code based on one selection, and may provide a menu for installation instructions or a menu for device information based on another selection. In another embodiment, a switch or dial is provided instead of a button, so that an installer can activate the interactive voice response based troubleshooting component at S240 by flipping the switch or turning the dial.

In another embodiment, the interactive voice response based troubleshooting component is initially activated, without use of a button or tactile input device, when an installer picks up a phone connected to the CPE and inputs a predetermined sequence of digits. The installer may be prompted, e.g., automatically the first time the CPE detects that an off-hook signal, to provide input to retrieve troubleshooting information. Alternatively, the installer may be prompted through an interactive menu only if the installer enters a predetermined access code. An exemplary announcement could be “Welcome to the installation troubleshooting menu, please press 123 to access the diagnostics menu, please press 456 for a listing of recent error codes”. In these examples, the CPE would passively monitor off-hook and input DTMF signals, and determine when the interactive voice response based troubleshooting component is being invoked.

The interactive voice response based troubleshooting component stores troubleshooting information and provides the troubleshooting information to the installer upon request. Troubleshooting information is information relating to the inability to successfully activate the CPE. Troubleshooting information may include both information relating to the nature and source of the problems, as well as information relating to solutions to the problems.

The CPE can be either a telephony device (e.g., an internet protocol telephone) or a peripheral (e.g., an analog terminal adapter) connected via a wire to a telephony device. The telephony device may be configured with a push-button keypad. The CPE may be configured to generate and/or recognize dual tone multi-frequency signals. Dual tone multi-frequency signals are the signals that are generated when a button on a push-button telephone keypad is pushed. Accordingly, the installer can communicate with the CPE by pressing keys on a telephone keypad.

At S250, the installer requests information, and the request is processed by the interactive voice response based troubleshooting functionality of the CPE. For example, if the CPE is an internet protocol telephone, keys on the internet protocol telephone can be pushed to request information at S250. Alternatively, if the CPE is an analog terminal adapter, keys on a telephone that is plugged into the analog terminal adapter can be pushed to request information at S250.

The CPE is configured to recognize particular input codes for particular requests. The CPE is configured to accept the codes as part of an interactive voice response based dialogue. For example, the CPE may be designed to support a request code of “3424” for entering the diagnosis menu. Additionally, after receiving the code to enter the diagnosis menu, the interactive voice response functionality of the CPE may instruct the installer to press 1 to hear the five most recent errors.

The CPE can be designed to announce error codes corresponding to the cause of the failure to activate. For example, the CPE can be designed to announce an error code “0051” to indicate “CPE failed to connect to file server”, an error code “0052” for “CPE failed to obtain configuration file”, an error code “0053” for “CPE failed to connect to registration server”, and an error code “0054” for “CPE failed to register”. The CPE may instruct the installer at every step using the interactive voice response based troubleshooting component. Alternatively, the installer may be expected to possess prior knowledge of which codes to input, so as to limit use of the interactive voice response based troubleshooting component. The CPE may also be configured to support numerous additional error codes for any other error that is anticipated to potentially cause failure in an attempt to install the CPE.

In another embodiment, a description of the errors is stated in words by the CPE, so that the installer does not have to memorize or research the meaning of a particular error code. In yet another embodiment, instead of announcing only the errors, a complete list of events including both errors and successes can be announced, such that the installing person not only knows when there are errors, but can also confirm when certain processes were successfully completed. In other embodiments, multiple lists can be supported, such as a complete event list and an error-event list, with the latter being a subset of the former.

In another embodiment, instead of announcing a fixed number of events, the events can be qualified by time. For example, the list of events announced by default can be the most recent events that occurred within the past twenty four hours. In still another embodiment, the events can be qualified by both number and time. For example, the list of events may be limited to up to the five most recent events that occurred within the past twenty four hours. The number of events and the time qualifier may be pre-configured on the CPE in the factory, and may be modifiable at a later date.

The request for information is analyzed at S264 to determine whether the request is for a diagnosis menu. If the request is for a diagnosis menu (S264=Yes), the diagnosis menu is provided at S274 using interactive voice response functionality, and the process loops back to S250 where another request for information is received.

If the request is not for a diagnosis menu (S264=No), a determination is made at S262 whether the request is for error codes. If the request is for error codes (S262=Yes), the error codes are provided at S272 using interactive voice response functionality and the process ends. If the request is not for error codes (S262=No), the requester is informed at S276 that the request is not recognized, and the process ends.

As described above, according to the embodiment shown in FIG. 2, the interactive voice response based troubleshooting component of the CPE equipment provides interactive voice responses to the installer's requests for information. Further, the interactive voice response based troubleshooting component of the CPE is itself activated in response to the installer's request.

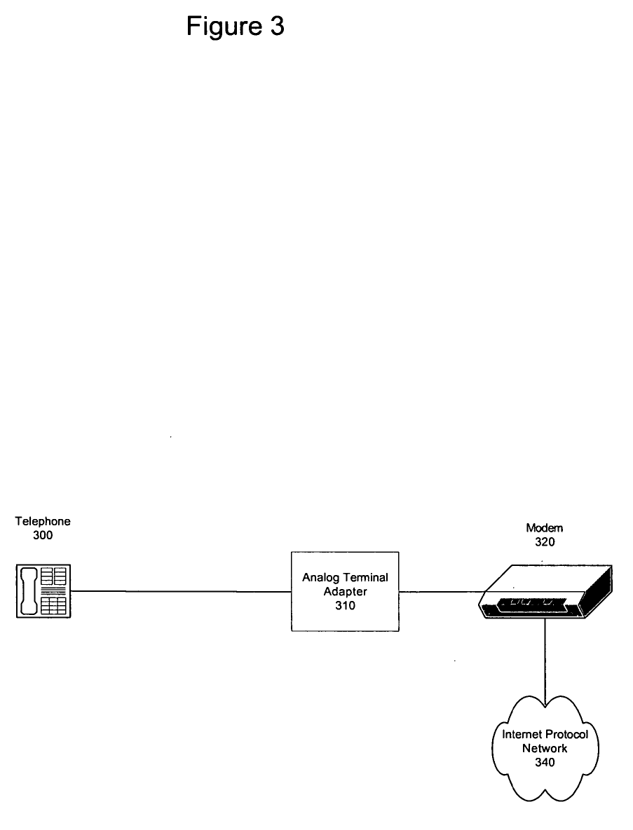

FIG. 3 shows an exemplary setup of CPE that is connected to a network. In the embodiment shown in FIG. 3, an analog telephone 300 is connected to an analog terminal adapter 310. The analog terminal adapter 310 is connected to a network 340 through a modem 320.

The analog terminal adapter 310 supports an interactive voice response based menu system which is managed through the analog phone 300. An installer connects the phone 300 to the analog terminal adapter 310, lifts the phone 300, presses a button on the analog terminal adapter 310 at S240 and enters the interactive voice response mode. In the interactive voice response mode, the installer is prompted by a recorded voice to enter values to obtain various information relating to an attempt to install the analog terminal adapter. As described previously, installation error codes may be presented by the interactive voice response based troubleshooting component of the analog terminal adapter 310. Accordingly, when installation fails, the installer can lift the phone, press the button on the CPE and enter the interactive voice response mode at S240. The installer may then enter a pre-designated key sequence to hear the diagnosis menu at S274 and/or to hear the recorded announcement of the error codes at S272.

According to the embodiments described above, when the installer suspects that the CPE installation has failed, the installer can obtain the reasons for failure by performing only a few simple actions. In an embodiment, where the CPE is an analog terminal adapter, the installer lifts the phone attached to the analog terminal adapter, presses the interactive voice response button on the analog terminal adapter in order to enter the interactive voice response mode, enters a key sequence into an attached telephone's keypad to obtain the diagnosis menu, and when prompted, presses keys on the phone to request information about the most recent system errors. Where the CPE is an internet protocol telephone, the installer presses the interactive voice response button on the internet protocol telephone in order to enter the interactive voice response mode.

When the installer presses a key to hear the most recent error, the installer may hear a recorded announcement “zero, zero, five, four”, followed by a timestamp, for example “Monday, Ten Thirty Eight AM”. This message would indicate the reason for the failure to activate the CPE. For example, “zero, zero, five, four” may indicate that the installation failed, not because of an error connecting to the file server, or an error obtaining a configuration file, or an error connecting to the registration server, but because the registration server rejected this CPE. In this example, the CPE may not have been properly provisioned on the VoIP network, or may be blocked from service for other reasons determined by the service provider. Based on this, the installer could call the back office to verify the service status instead of trying out another piece of CPE.

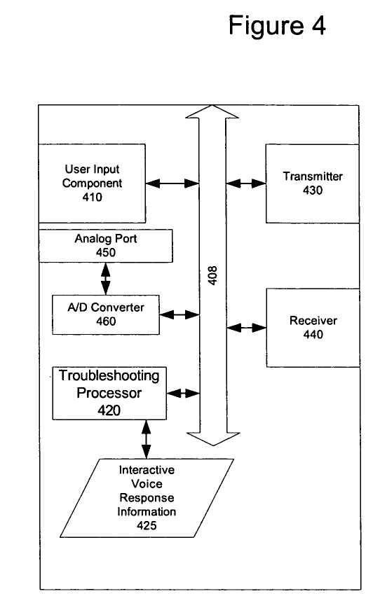

FIG. 4 shows exemplary CPE by which interactive voice response based troubleshooting of customer premise equipment installation can be provided. Only a few exemplary components of the CPE are shown in FIG. 4. However, the CPE may contain additional components such as the various components of the general computer system shown in FIG. 1.

In the embodiment shown in FIG. 4, the exemplary CPE is an analog terminal adapter. An analog port 450 interfaces with an analog jack from an analog telephone, and analog input from the analog telephone is converted to digital signals by an analog-to-digital (A/D) converter 460. The A/D converter communicates with other components of the CPE over a system bus 408. The CPE shown in FIG. 4 also includes a transmitter 430 and a receiver 440 for communicating over a VoIP network. Accordingly, the analog terminal adapter shown in FIG. 4 can be used to interface an analog telephone to an internet protocol network.

The exemplary CPE in FIG. 4 includes a user input component 410. The user input component 410 may be a button that is dedicated to the interactive voice response based troubleshooting of customer premise equipment installation. Alternatively, the user input component 410 may be a switch or a dial. Further, in an embodiment, the user input component 410 may be used to select interactive voice response based “troubleshooting” among a variety of interactive voice response based options, such as equipment identification or a menu of audible installation instructions.

The CPE in FIG. 4 includes an interactive voice response based troubleshooting component (not labeled), with a troubleshooting processor 420 and an interactive voice response information 425. The troubleshooting processor 420 recognizes when a user presses the user input component 410 to activate the interactive voice response based troubleshooting component of the CPE. The troubleshooting processor 420 executes a program that waits for the user to select an option by inputting dual tone multi-frequency codes. Alternatively, the troubleshooting processor 420 processes an instruction to immediately prompt the user to select an option by inputting dual tone multi-frequency codes.

Accordingly, by activating an interactive voice response based troubleshooting component of the CPE, a user is able to receive detailed information relating to a failed attempt to activate the CPE. The detailed information is made available without requiring a personal computer, and without requiring a working connection to the network. In fact, as explained herein, the interactive voice response based troubleshooting component of the CPE assists a user in obtaining a working connection to a network where no working connection yet exists.

As explained herein, a troubleshooting interactive voice response menu can be implemented on VoIP CPE including, but not limited, to an analog terminal adapter and an internet protocol phone. The interactive voice response based troubleshooting of customer premise equipment installation can also be used to troubleshoot other devices, such as an integrated access device (IAD) or a residential gateway. Further, the present invention is not limited to VoIP CPE. Rather, the interactive voice response based troubleshooting component of the CPE finds use in any processor-based device that is configured to provide audio output, and is useful in any situation where such a device is to be activated over a network in order to operate.

Although the present specification describes components and functions that may be implemented in particular embodiments with reference to particular standards and protocols, the invention is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A method for installing customer premise equipment, the method comprising:
sending information from customer premise equipment over a communications network to attempt to activate the customer premise equipment;
receiving a request to activate an interactive voice response based troubleshooting component of the customer premise equipment; and
providing information relating to the attempt to activate the customer premise equipment using the interactive voice response based troubleshooting component of the customer premise equipment.

2. The method for installing customer premise equipment of claim 1,
wherein the customer premise equipment is voice over internet protocol customer premise equipment.

3. The method for installing customer premise equipment of claim 2,
wherein the voice over internet protocol customer premise equipment is one of an analog terminal adapter and an internet protocol phone.

4. The method for installing customer premise equipment of claim 2,
wherein the voice over internet protocol customer premise equipment is one of an integrated access device and a residential gateway.

5. The method for installing customer premise equipment of claim 1,
further comprising receiving the request as dual tone multi-frequency tones.

6. The method for installing customer premise equipment of claim 1,
wherein the information comprises a diagnosis menu.

7. The method for installing customer premise equipment of claim 1, wherein the information comprises an error code corresponding to a reason the attempt to activate the customer premise equipment has failed.

8. A computer readable medium for storing a computer program that provides information for installing customer premise equipment, the computer readable medium comprising:
an information sending code segment that sends information from customer premise equipment over a communication network to attempt to activate the customer premise equipment;
a request receiving code segment that receives a request to activate an interactive voice response based troubleshooting component of the customer premise equipment; and
an information providing code segment that provides information relating to the attempt to activate the customer premise equipment using the interactive voice response based troubleshooting component of the customer premise equipment.

9. The computer readable medium of claim 8,
wherein the customer premise equipment is voice over internet protocol customer premise equipment.

10. The computer readable medium of claim 9,
wherein the voice over internet protocol customer premise equipment is one of an analog terminal adapter and an internet protocol phone.

11. The computer readable medium of claim 9,
wherein the voice over internet protocol customer premise equipment is one of an integrated access device and a residential gateway.

12. The computer readable medium of claim 8,
wherein the request is received as dual tone multi-frequency tones.

13. The computer readable medium of claim 8,
wherein the information comprises a diagnosis menu.

14. The computer readable medium of claim 8,
wherein the information comprises an error code corresponding to a reason the attempt to active the customer premise equipment has failed.

15. Customer premise equipment, comprising:
a transmitter that sends information over a communications network to attempt to activate the customer premise equipment;
an interactive voice response based troubleshooting component that provides information relating to the attempt to activate the customer premise equipment; and
an input component that receives a request to activate the interactive voice response based troubleshooting component of the customer premise equipment.

16. The customer premise equipment of claim 15,
wherein the customer premise equipment is voice over internet protocol customer premise equipment.

17. The customer premise equipment of claim 16,
wherein the voice over internet protocol customer premise equipment is one of an analog terminal adapter and an internet protocol phone.

18. The customer premise equipment of claim 16,
wherein the voice over internet protocol customer premise equipment is one of an integrated access device and a residential gateway.

19. The customer premise equipment of claim 15,
wherein the request is received as dual tone multi-frequency tones.

20. The customer premise equipment of claim 15,
wherein the information comprises a diagnosis menu.

21. The customer premise equipment of claim 15,
wherein the information comprises an error code corresponding to a reason the attempt to activate the customer premise equipment has failed.

22. The customer premise equipment of claim 15, said interactive voice response based troubleshooting component comprising: a troubleshooting processor and interactive voice response troubleshooting instructions.
